(19) United States
(12) Patent Application Publication
(10) Pub. No.: US 2012/0113129 A1
(43) Pub. Date: May 10, 2012

(54) Apparatus and method for generating realistic pose including texture

(75) Inventors: Tae Hyun Rhee, Yongin-si (KR); Hee Sae Lee, Yongin-si (KR); Young Ihn Kho, Seoul (KR)

(73) Assignee: SAMSUNG ELECTRONICS CO., LTD., Suwon-si (KR)

(21) Appl. No.: 13/137,306

(22) Filed: Aug. 4, 2011

(30) Foreign Application Priority Data
Nov. 4, 2010 (KR) 10-2010-0109141

(51) Int. Cl. G09G 5/00

(52) U.S. Cl. 345/582

(57) ABSTRACT

Provided is a realistic pose generating apparatus that may render an input pose by deforming a basic shape to a shape of the input pose based on a displacement value of a shape corresponding to a difference between a shape interpolation function with respect to the input pose and the shape interpolation function with respect to each of major poses, and by deforming a basic texture to a texture of the input pose based on a displacement value of a texture corresponding to a difference between a texture interpolation function with respect to the input pose and the texture interpolation function with respect to each of the major poses.

### CROSS-REFERENCE TO RELATED APPLICATIONS

This application claims the benefit of Korean Patent Application No. 10-2010-0109141, filed on Nov. 4, 2010, in the Korean Intellectual Property Office, the disclosure of which is incorporated herein by reference.

### BACKGROUND

1. Field

One or more example embodiments of the present disclosure relate to an apparatus and method for generating a realistic pose including a texture.

2. Description of the Related Art

With developments in three-dimensional (3D) graphics technology and related hardware technology, demand for technology to realistically express a human being is currently increasing in a variety of application fields such as 3D games, movies, content creation, and the like. In particular, the face of a person may be an important factor for expressing a variety of information and features of the person and thus, relatively great effort on expressing the face of a human being may be used for creation of a realistic 3D avatar.

The face of the human being is one of the body portions most sensitively recognized by others. Therefore, even a subtle error in shape or in an expression may be sensitively recognized compared to other portions. When the face of the human being is animated using only the shape, high definition shape information may be used to express minute wrinkles, sweat pores, and the like. A relative large memory and a relatively large number of calculations may be used. The above constraints may also occur for other body portions in addition to the face animation. Accordingly, there is a desire for a method that may efficiently express a minute texture, for example, wrinkles, sweat pores, and the like.

### SUMMARY

The foregoing and/or other aspects are achieved by providing an apparatus for generating a realistic pose including a texture, including: a function generation module to generate a shape interpolation function and a texture interpolation function with respect to each of predetermined major poses; a displacement calculation module to calculate a displacement value of a shape using the shape interpolation function with respect to an input pose, and to calculate a displacement value of a texture using the texture interpolation function with respect to the input pose; a deformation module to deform a basic shape to a shape of the input pose based on the displacement value of the shape, and to deform a basic texture to a texture of the input pose based on the displacement value of the texture; and a rendering module to render the input pose using the shape of the input pose and the texture of the input pose.

The function generation module may generate the shape interpolation function and the texture interpolation function based on a correlation between the major poses and a weight with respect to the correlation.

The function generation module may include: a shape interpolation function generator to generate the shape interpolation function by calculating a correlation between the major poses based on a pose vector of each of the major poses, and by calculating a weight with respect to a shape of each of the major poses based on the shape of each of the major poses; and a texture interpolation function generator to generate the texture interpolation function by calculating the correlation between the major poses based on the pose vector of each of the major poses, and by calculating a weight with respect to a texture of each of the major poses based on the texture of each of the major poses.

The displacement calculation module may further include: a generator to generate the shape and the texture of the input pose as a shape and a texture corresponding to a space expressed by the major poses by inputting a vector of the input pose into each of the shape interpolation function and the texture interpolation function; and a calculator to calculate a displacement value of each of a shape and a texture for expressing, in the space expressed by the major poses, a pose input from the shape and the texture corresponding to the space expressed by the major poses.

The rendering module may render the input pose based on the shape of the input pose, the texture of the input pose, and a correlation between the basic shape and the basic texture appearing in the basic shape.

The apparatus may further include a database to store pose vectors of the major poses, shapes of the major poses, textures of the major poses, and a correlation between the basic shape and the basic texture.

The basic shape may correspond to either one of shapes of the major poses, or a shape different from the shapes of the major poses.

The foregoing and/or other aspects are achieved by providing a method of generating a realistic pose including a texture, including: generating a shape interpolation function and a texture interpolation function with respect to each of predetermined major poses; calculating a displacement value of a shape using the shape interpolation function with respect to an input pose, and calculating a displacement value of a texture using the texture interpolation function with respect to the input pose; deforming a basic shape to a shape of the input pose based on the displacement value of the shape, and deforming a basic texture to a texture of the input pose based on the displacement value of the texture; and rendering the input pose using the shape of the input pose and the texture of the input pose.

The generating may include generating the shape interpolation function and the texture interpolation function based on a correlation between the major poses and a weight with respect to the correlation.

The generating may include: generating the shape interpolation function by calculating a correlation between the major poses based on a pose vector of each of the major poses, and by calculating a weight with respect to a shape of each of the major poses based on the shape of each of the major poses; and generating the texture interpolation function by calculating the correlation between the major poses based on the pose vector of each of the major poses, and by calculating a weight with respect to a texture of each of the major poses based on the texture of each of the major poses.

The calculating may include: generating the shape and the texture of the input pose as a shape and a texture corresponding to a space expressed by the major poses by inputting a vector of the input pose into each of the shape interpolation function and the texture interpolation function; and calculating a displacement value of each of a shape and a texture for expressing, in the space expressed by the major poses, a pose input from the shape and the texture corresponding to the space expressed by the major poses.

The rendering may include rendering the input pose based on the shape of the input pose, the texture of the input pose, and a correlation between the basic shape and the basic texture appearing in the basic shape.

The method may further include maintaining a database to store pose vectors of the major poses, shapes of the major poses, textures of the major poses, and a correlation between the basic shape and the basic texture.

The basic shape may correspond to either one of the shapes of the major poses, or a shape different from the shapes of the major poses.

The foregoing and/or other aspects are achieved by providing an apparatus for generating a realistic pose to be rendered. The apparatus includes a processor to control one or more processor-executable modules, a function generation module to generate a shape interpolation function and a texture interpolation function with respect to each of a plurality of predetermined poses based on a correlation between the predetermined poses and a weight with respect to the correlation, a displacement calculation module to calculate, with respect to an input pose, a displacement value of a shape using the generated shape interpolation function and a displacement value of a texture using the generated texture interpolation function, and a deformation module to deform a basic shape to a shape of the input pose based on the calculated displacement value of the shape and to deform a basic texture to a texture of the input pose based on the calculated displacement value of the texture.

The foregoing and/or other aspects are achieved by providing a method of generating a realistic pose to be rendered. The method includes generating a shape interpolation function and a texture interpolation function with respect to each of a plurality of predetermined poses based on a correlation between the predetermined poses and a weight with respect to the correlation, calculating, with respect to an input pose, a displacement value of a shape using the generated shape interpolation function and a displacement value of a texture using the generated texture interpolation function, and deforming, by way of a processor, a basic shape to a shape of the input pose based on the calculated displacement value of the shape and to deform a basic texture to a texture of the input pose based on the calculated displacement value of the texture.

According to example embodiments, it is possible to effectively express an input pose to be more minute and realistic by calculating a displacement value of each of a shape and a texture with respect to the input pose based on a correlation between each of shapes of predetermined major poses and each of textures thereof, and without using a large amount of calculations.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an apparatus for generating a realistic pose including a texture according to example embodiments;

FIG. 2 illustrates predetermined major poses used for a realistic pose generating apparatus including a texture according to example embodiments;

FIG. 3 illustrates a basic shape used for a realistic pose generating apparatus including a texture according to example embodiments; and

FIG. 4 illustrates a method of generating a realistic pose including a texture according to example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

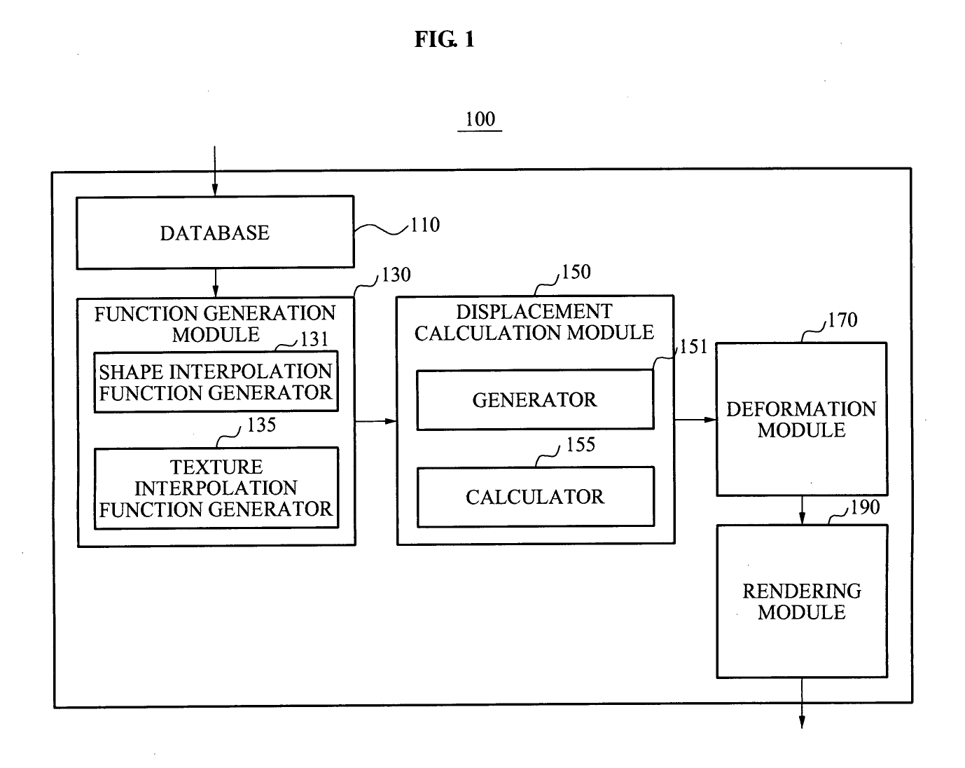

FIG. 1. illustrates an apparatus 100 for generating a realistic pose including a texture according to example embodiments.

Referring to FIG. 1, the realistic pose generating apparatus 100 may include, for example, a database 110, a function generation module 130, a displacement calculation module 150, a deformation module 170, and a rendering module 190.

The database 110 may include information stored in memory such as pose vectors of major poses, shapes of the major poses, textures or texture maps of the major poses, and a correlation between one or more basic shapes and basic textures.

Here, the correlation between the basic shape and the basic texture may be referred to as texture coordinates.

The function generation module 130 may generate a shape interpolation function and a texture interpolation function with respect to each of a plurality of predetermined major poses. Prior to generating a three-dimensional (3D) model or animation with respect to an input pose, the function generation module 130 may generate in advance the shape interpolation function and the texture interpolation function based on the information stored in the database 110.

The function generation module 130 may generate an interpolation function, for example, a radial basis function, for implementing a soft interpolation in a pose space including pose vectors with respect to the major poses.

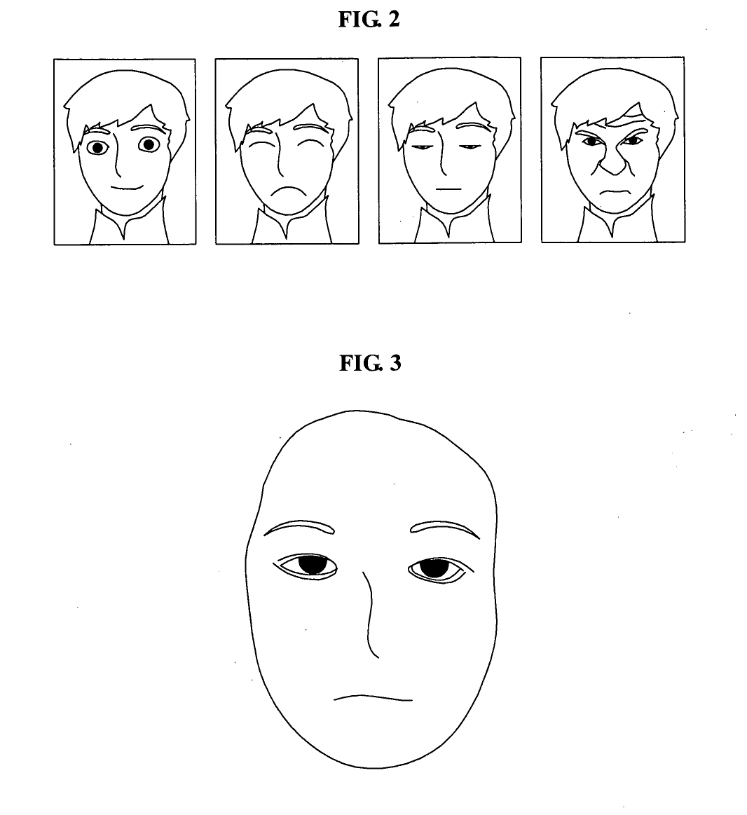

The predetermined major poses will be further described with reference to FIG. 2.

The function generation module 130 may generate the shape interpolation function and the texture interpolation function based on a correlation between the major poses, and a weight with respect to the correlation.

The function generation module 130 may include a shape interpolation function generator 131 and a texture interpolation function generator 135.

The shape interpolation function generator 131 may calculate the correlation between the major poses input from the database 110, based on the pose vectors of the major poses and the shapes of the major poses. The correlation may be expressed by φ(∥Eᵢ−Eₖ∥). The shape interpolation function generator 131 may generate the shape interpolation function by calculating a weight with respect to a shape of each of the major poses using a linear system based on the shape of each of the major poses.

The shape interpolation function F(mᵢ) generated by the shape interpolation function generator 131 may be expressed by Equation 1 below.

$$F ( {m}_{i} ) = {\sum }_{k = 1}^{n} {r}_{k} ϕ ( ‖ {E}_{i} - {E}_{k} ‖ ) \qquad [ Equation 1 ]$$

In Equation 1, Eᵢ corresponds to a pose factor of one of the major poses, Eₖ corresponds to a pose vector with respect to each of remaining major poses excluding Eᵢ, and rₖ corresponds to an interpolation weight with respect to a shape of each of the major poses.

Also, mᵢ corresponds to a shape of each of the poses.

For example, when it is assumed that eight major poses are input from the database 110, the shape interpolation function generator 131 may calculate a correlation between a pose vector with respect to a shape of a number 1 major pose and each of number 2 through number 8 major poses excluding the number 1 major pose. The above calculation process may be performed with respect to pose vectors starting from a pose vector with respect to the shape of the number 1 major pose to a pose vector with respect to a shape of the number 8 major pose.

The weight rₖ with respect to the shape of each of the major poses may be calculated using the linear system based on pose vectors with respect to the shape.

The texture interpolation function generator 135 may generate the texture interpolation function by calculating the correlation between the major poses input from the database 110 based on the pose vectors of the major poses and the textures or the texture maps of the major poses, and by calculating the weight with respect to the texture of each of the major poses using the texture of each of the major poses. The correlation between the major poses may be expressed by φ(∥Eᵢ−Eₖ∥).

The texture interpolation function F(tᵢ) generated by the texture interpolation function generator 135 may be expressed by Equation 2 below.

$$F ( {t}_{i} ) = {\sum }_{k = 1}^{n} {r}_{k} ϕ ( ‖ {E}_{i} - {E}_{k} ‖ ) \qquad [ Equation 2 ]$$

In Equation 2, E, corresponds to a pose factor of one of the major poses, Eₖ corresponds to a pose vector with respect to each of remaining major poses excluding Eᵢ, and rₖ corresponds to an interpolation weight with respect to the shape of each of the major poses.

Also, tᵢ corresponds to a texture of each of the poses.

The texture interpolation function generator 135 may also generate the texture interpolation function using the same scheme as used by the shape interpolation function generator 131.

The displacement calculation module 150 may calculate a displacement value of a shape using the shape interpolation function with respect to a pose input from a frame, and may calculate a displacement value of a texture using the texture interpolation function with respect to the input pose.

New values, for example, a value of F(m) and a value of F(t) in a pose space with respect to the input pose may be calculated using the aforementioned shape interpolation function and texture interpolation function.

For example, the shape interpolation function F(m) with respect to the input pose Eₐ may be expressed by Equation 3 below. The texture interpolation function F(t) with respect to the input pose Eₐ may be expressed by Equation 4 below.

$$\begin{matrix}F ( m ) = {\sum }_{k = 1}^{n} {r}_{k} ϕ ( ‖ {E}_{a} - {E}_{k} ‖ ) & [ Equation 3 ] \\ F ( t ) = {\sum }_{k = 1}^{n} {r}_{k} ϕ ( ‖ {E}_{a} - {E}_{k} ‖ ) & [ Equation 4 ]\end{matrix}$$

The displacement calculation module 150 may further include a generator 151 and a calculator 155.

The generator 151 may generate the shape and the texture of the input pose as a shape and a texture corresponding to a space expressed by the major poses by inputting a vector of the input pose into each of the shape interpolation function and the texture interpolation function.

The calculator 155 may calculate a displacement value of each of a shape and a texture for expressing, in the space expressed by the major poses, a pose input from the shape and the texture corresponding to the space expressed by the major poses.

The deformation module 170 may deform a basic shape to a shape of the input pose based on the displacement value of the shape, and may deform a basic texture to a texture of the input pose based on the displacement value of the texture.

Here, the basic shape may correspond to any of the shapes of the major poses, or a shape different from the shapes of the major poses. The basic shape will be further described with reference to FIG. 3.

The rendering module 190 may render the input pose based on a shape of the input pose and a texture of the input pose.

The rendering module 190 may render the input pose based on the shape of the input pose, the texture of the input pose, and a correlation between the basic shape and a basic texture appearing in the basic shape.

The rendering module 190 may realistically express the shape of the input pose and the texture of the input pose as a new facial expression according to the input pose and a texture according to the new facial expression. For example, the rendering module 190 may reflect wrinkles, a reflected portion, a shadow, and the like occurring due to the new facial expression.

FIG. 2 illustrates predetermined major poses used for a realistic pose generating apparatus including a texture according to one or more example embodiments.

The predetermined major poses may correspond to poses used to generate, as a 3D model or animation, a pose that is input from a frame. For example, when the input pose relates to a face, various types of facial poses, for example, a smiling face, an angry face, a frowning face, a gloomy face, a crying face, and the like, may correspond to the predetermined major poses.

A pose to be generated may be assumed as the whole body or a portion, for example, a leg of a body of a human being.

In the above assumption, the predetermined major poses may include a variety of leg-related poses, for example, a walking pose, a running pose, a seating pose, a pose with legs closed, and the like.

FIG. 3 illustrates a basic shape used for a realistic pose generating apparatus including a texture according to example embodiments.

Referring to FIG. 3, the basic shape may be a reference shape for applying a displacement value of a shape when a pose input from a frame is to be generated as a 3D model or animation. For example, when a face is animated, a shape of an expressionless face may be a basic shape, or one of the shapes of predetermined major poses, for example, a smiling face, an angry face, a frowning face, a gloomy face, a crying face, and the like, may correspond to the basic shape.

When legs are animated, a shape with respect to a standing pose may correspond to the basic shape, or one of the shapes with respect to predetermined poses, for example, a walking pose, a running pose, a seated pose, a closed-legs pose, and the like may correspond to the basic shape.

As described above, the basic texture refers to a texture appearing in the basic shape. For example, when the expressionless face corresponds to the basic shape as shown in FIG. 3, wrinkles, sweat pores, skin tone, and the like appearing on the expressionless face may correspond to the basic texture.

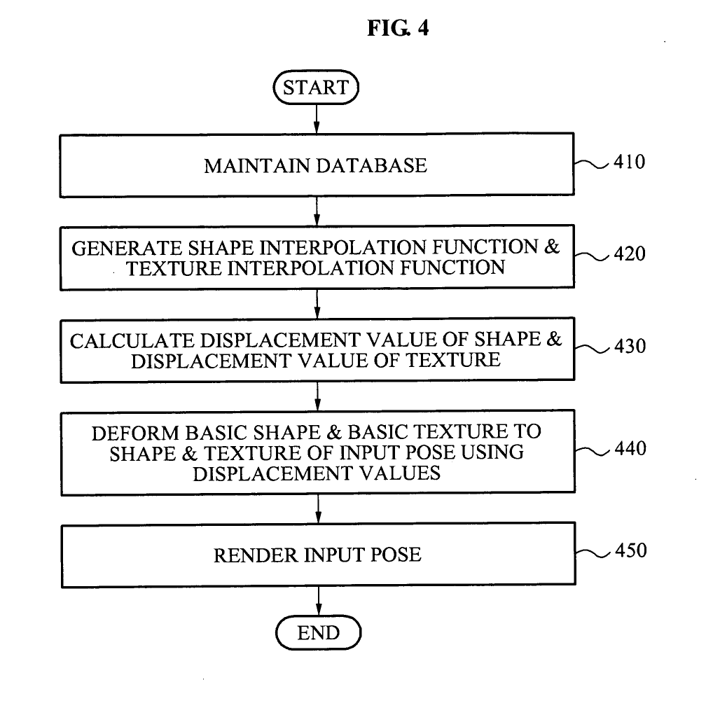

FIG. 4 illustrates a method of generating a realistic pose including a texture according to example embodiments.

Referring to FIG. 4, in operation 410, a realistic pose generating apparatus (hereinafter, a “pose generating apparatus”) including a texture may maintain a database to store pose vectors of the major poses, shapes of the major poses, textures of the major poses, and a correlation between the basic shapes and the basic textures.

In operation 420, the pose generating apparatus may generate a shape interpolation function and a texture interpolation function with respect to each of predetermined major poses.

The pose generating apparatus may generate the shape interpolation function and the texture interpolation function based on a correlation between the major poses, and a weight with respect to the correlation.

For example, the pose generating apparatus may generate the shape interpolation function by calculating the correlation between the major poses based on pose vectors of the major poses and shapes of the major poses, and by calculating a weight with respect to a shape of each of the major poses based on the shape of each of the major poses. Here, the correlation may be expressed by φ(∥Eᵢ−Eₖ∥).

In operation 430, the pose generating apparatus may calculate a displacement value of a shape using the shape interpolation function with respect to a pose input from a frame, and may calculate a displacement value of a texture using the texture interpolation function with respect to the input pose.

In operation 430, the pose generating apparatus may generate the shape and the texture of the input pose as a shape and a texture corresponding to a space expressed by the major poses by inputting a vector of the input pose into each of the shape interpolation function and the texture interpolation function. The pose generating apparatus may calculate a displacement value of each of a shape and a texture for expressing, in the space expressed by the major poses, a pose input from the shape and the texture corresponding to the space expressed by the major poses.

In operation 440, the pose generating apparatus may deform a basic shape to a shape of the input pose based on the displacement value of the shape, and may deform a basic texture to a texture of the input pose based on the displacement value of the texture.

In operation 450, the pose generating apparatus may render the input pose using the shape of the input pose and the texture of the input pose.

The pose generating apparatus may render the input pose based on the shape of the input pose, the texture of the input pose, and the correlation between the basic shape and the basic texture appearing in the basic shape.

The realistic pose generating method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like.

Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa. Any one or more of the software modules described herein may be executed by a dedicated processor unique to that unit or module or by a processor common to one or more of the modules. The described methods may be executed on general purpose computer or processor or may be executed on a particular machine such as the apparatus for generating a realistic pose comprising a texture described herein.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An apparatus for generating a realistic pose comprising a texture, comprising:
a processor to control one or more processor-executable modules;
a function generation module to generate a shape interpolation function and a texture interpolation function with respect to each of a plurality of predetermined major poses;
a displacement calculation module to calculate a displacement value of a shape using the shape interpolation function with respect to an input pose and to calculate a displacement value of a texture using the texture interpolation function with respect to the input pose;
a deformation module to deform a basic shape to a shape of the input pose based on the displacement value of the shape and to deform a basic texture to a texture of the input pose based on the displacement value of the texture; and
a rendering module to render the input pose using the shape of the input pose and the texture of the input pose.

2. The apparatus of claim 1, wherein the function generation module generates the shape interpolation function and the texture interpolation function based on a correlation between the major poses and a weight with respect to the correlation.

3. The apparatus of claim 1, wherein the function generation module comprises:
a shape interpolation function generator to generate the shape interpolation function by calculating a correlation between the major poses based on a pose vector of each of the major poses, and by calculating a weight with respect to a shape of each of the major poses based on the shape of each of the major poses; and
a texture interpolation function generator to generate the texture interpolation function by calculating the correlation between the major poses based on the pose vector of each of the major poses, and by calculating a weight with respect to a texture of each of the major poses based on the texture of each of the major poses.

4. The apparatus of claim 1, wherein the displacement calculation module further comprises:
a generator to generate the shape and the texture of the input pose as a shape and a texture corresponding to a space expressed by the major poses by inputting a vector of the input pose into each of the shape interpolation function and the texture interpolation function; and
a calculator to calculate a displacement value of each of a shape and a texture for expressing, in the space expressed by the major poses, a pose input from the shape and the texture corresponding to the space expressed by the major poses.

5. The apparatus of claim 1, wherein the rendering module renders the input pose based on the shape of the input pose, the texture of the input pose, and a correlation between the basic shape and the basic texture appearing in the basic shape.

6. The apparatus of claim 1, further comprising:
a memory including a database to store pose vectors of the major poses, shapes of the major poses, textures of the major poses, and a correlation between the basic shape and the basic texture appearing in the basic shape.

7. The apparatus of claim 1, wherein the basic shape corresponds to either one of shapes of the major poses, or a shape different from the shapes of the major poses.

8. A method of generating a realistic pose comprising a texture, comprising:
generating a shape interpolation function and a texture interpolation function with respect to each of a plurality of predetermined major poses;
calculating a displacement value of a shape using the generated shape interpolation function with respect to an input pose and calculating a displacement value of a texture using the generated texture interpolation function with respect to the input pose;
deforming a basic shape to a shape of the input pose based on the displacement value of the shape, and deforming a basic texture to a texture of the input pose based on the displacement value of the texture; and
rendering, by way of a processor, the input pose using the shape of the input pose and the texture of the input pose.

9. The method of claim 8, wherein the generating comprises generating the shape interpolation function and the texture interpolation function based on a correlation between the major poses and a weight with respect to the correlation.

10. The method of claim 8, wherein the generating comprises:
generating the shape interpolation function by calculating a correlation between the major poses based on a pose vector of each of the major poses, and by calculating a weight with respect to a shape of each of the major poses based on the shape of each of the major poses; and
generating the texture interpolation function by calculating the correlation between the major poses based on the pose vector of each of the major poses, and by calculating a weight with respect to a texture of each of the major poses based on the texture of each of the major poses.

11. The method of claim 8, wherein the calculating comprises:
generating the shape and the texture of the input pose as a shape and a texture corresponding to a space expressed by the major poses by inputting a vector of the input pose into each of the shape interpolation function and the texture interpolation function; and
calculating a displacement value of each of a shape and a texture for expressing, in the space expressed by the major poses, a pose input from the shape and the texture corresponding to the space expressed by the major poses.

12. The method of claim 8, wherein the rendering comprises rendering the input pose based on the shape of the input pose, the texture of the input pose, and a correlation between the basic shape and the basic texture appearing in the basic shape.

13. The method of claim 8, further comprising:
maintaining a database to store pose vectors of the major poses, shapes of the major poses, textures of the major poses, and a correlation between the basic shape and the basic texture appearing in the basic shape.

14. The method of claim 8, wherein the basic shape corresponds to either one of the shapes of the major poses, or a shape different from the shapes of the major poses.

15. A non-transitory computer-readable medium comprising a program for instructing a computer to perform the method of claim 8.

16. An apparatus for generating a realistic pose to be rendered, the apparatus comprising:
a processor to control one or more processor-executable modules;
a function generation module to generate a shape interpolation function and a texture interpolation function with respect to each of a plurality of predetermined poses based on a correlation between the predetermined poses and a weight with respect to the correlation;
a displacement calculation module to calculate, with respect to an input pose, a displacement value of a shape using the generated shape interpolation function and a displacement value of a texture using the generated texture interpolation function; and
a deformation module to deform a basic shape into a shape of the input pose based on the calculated displacement value of the shape and to deform a basic texture into a texture of the input pose based on the calculated displacement value of the texture.

17. The apparatus of claim 16, further comprising:
a rendering module to render the input pose based on the shape of the input pose, the texture of the input pose, and a correlation between the basic shape and the basic texture appearing in the basic shape.

18. A method of generating a realistic pose to be rendered, the method comprising:
generating a shape interpolation function and a texture interpolation function with respect to each of a plurality of predetermined poses based on a correlation between the predetermined poses and a weight with respect to the correlation;
calculating, with respect to an input pose, a displacement value of a shape using the generated shape interpolation function and a displacement value of a texture using the generated texture interpolation function; and
deforming, by way of a processor, a basic shape into a shape of the input pose based on the calculated displacement value of the shape and to deform a basic texture into a texture of the input pose based on the calculated displacement value of the texture.

19. The method of claim 18, further comprising:
rendering the input pose based on the shape of the input pose, the texture of the input pose, and a correlation between the basic shape and the basic texture appearing in the basic shape.

20. A non-transitory computer-readable medium comprising a program for instructing a computer to perform the method of claim 18.
